(19) United States
(12) Patent Application Publication
(10) Pub. No.: US 2025/0227673 A1
(43) Pub. Date: Jul. 10, 2025

(54) SUPPORTING MULTIPLE BEARERS FOR UE WITH LIMITED LCIDs

(71) Applicant: Rakuten Symphony, Inc., Tokyo (JP)

(72) Inventors: Nirav SALOT, Bangalore (IN); Pradeep Kumar NALLA, Bangalore (IN); Rahul MODI, Bangalore (IN); Satish Reddy KUNDURU, Bangalore (IN); Sridhar BHASKARAN, Bangalore (IN)

(21) Appl. No.: 18/689,399

(22) PCT Filed: Dec. 5, 2023
(86) PCT No.: PCT/US2023/082562

§ 371 Date: Mar. 5, 2024

(30) Foreign Application Priority Data
Aug. 31, 2023 (IN) 202341058492
Oct. 27, 2023 (IN) 202341058492

(51) Int. Cl. H04W 72/0453; H04W 28/26; H04W 72/02; H04W 76/30

(52) U.S. Cl. CPC H04W 72/0453; H04W 28/26; H04W 72/02; H04W 76/30

(57) ABSTRACT

Methods to overcome Logical Channel ID (LCID) limitations during bearer type switching when multiple ENDC bearers are supported. Initially, the method recites determining a configuration mode of a bearer to be added for the UE, which may be either MCG mode or SCG-split mode. Further, the method recites allocating an LCID to the bearer based on the configuration mode and one or more criteria. The method recites performing, upon detecting an addition of a secondary node in the communication network by checking whether LCIDs are available for allocating corresponding bearers requiring SCG-split mode in response to the addition of the secondary node. The method further recites assigning the LCIDs to the corresponding bearers requiring the SCG-split mode, when the LCIDs are available for the bearers and switching a set of bearers, among the bearers, into the SCG-split mode when the LCIDs are available only for the set of bearers.

### TECHNICAL FIELD

The present disclosure generally relates to wireless communication system. More particularly, the present disclosure relates to method, system and computer program to support multiple bearers for a user equipment (UE) with a limited Logical Channel Identifier (LCID) in a communication network.

### BACKGROUND

According to 3GPP standards documents, E-UTRAN New Radio Dual Connectivity (ENDC) allows a user equipment (UE) to connect to an LTE eNodeB that acts as a master node and a 5G gNodeB that acts as a secondary node. Further, in LTE, Broadband Network Quality of Service (QOS) is implemented between the UE and Packet Data Network Gateway (PDN) Gateway and the QoS is applied to a set of bearers. The bearer is a virtual concept and is a set of network configurations to provide special treatment to a set of traffic e.g., VoIP packets are prioritized by network compared to web browser traffic. In the ENDC, there are three types of bearers from the UE perspective i.e., Master Cell Group (MCG) bearer, Secondary Cell Group (SCG) bearer, and Split bearer. The MCG Bearer is a bearer which is terminating at Master Node (MN) node (in case of ENDC, more specifically at eNodeB) and the SCG Bearer is a bearer terminating at Secondary Node (SN) node (in case of ENDC, more specifically at gNB). The MCG bearer can be configured with either E-PDCP or NR-PDCP, whereas the SCG bearer is always configured with New-Radio Packet Data Convergence Protocol (NR-PDCP). Further, the Split Bearer is a bearer for which traffic is routed via LTE and/or NR bearer. Thus, the Split bearer can be either SCG split or MCG split. In the MCG Split bearer, the traffic is split at the MN node and in the SCG Split Bearer, the traffic is split at the SN node.

In ENDC, a change in the bearer type requires either a Primary Cell (PCell) handover or a Primary SCells (PSCell) change (which triggers Media Access Control (MAC) reset and Radio link control (RLC) re-establishment) or a change in Logical Channel ID (LCID) as specified in 3GPP TS 37.340, where the change in LCID is the most optimal solution for bearer type change. The change in bearer type may be due to transition from the MCG bearer to the SCG Split bearer or vice versa. Such transition in the bearer type may occur during a SN addition, release or change or during some new bearer addition (e.g., QoS Class Identifier (QCI 1) bearer addition leads to all bearers changing back to the MCG bearer) as per Annex A of 3GPP TS 37.340. The QCI stands for QoS class identifier and in LTE, the QCIs may include QCI-1, QCI-2, QCI-3, QCI-4, QCI-5, QCI-6, QCI-7, QCI-8 and QCI-9 class identifiers. The priority associated with each QCI is applied when forwarding packets across the LTE network. For example, a priority of 1 corresponds to highest one. Even though there are different methods recommended by 3GPP to support bearer type change, but LCID change based mechanism is the least disruptive towards the UE and hence it is beneficial to implement it that way.

Generally, LTE supports 8 LCIDs (3 . . . 10) up to 3GPP Rel 14. However, 3GPP Rel 15 onwards 15 LCIDs (Normal 3 . . . 10 & Extended LCID 32 . . . 38) & total 15 bearers are supported. The number of supported LCIDs is signaled in UE capabilities via Radio Resource Control (RRC). To support multiple ENDC bearers more LCIDs may be needed. For instance, assume there is a need to support 3 Master Cell Group (MCG) bearers and 4 SCG split bearers for a UE. During the UE attach process, the first 3 MCG bearers may be admitted. As a result, LCIDs: 3, 4, and 5 may be consumed and the Secondary Node (SN) is still not added. Further, the next 4 bearers may be admitted as MCG bearers, thus LCIDs: 6, 7, 8, and 9 may be consumed. If any measurement is received for the SN addition, a system has to convert the four MCG bearers to split bearers. Thus, an eNB needs to change the LCID of the bearers which are going to transit from the MCG bearer to the SCG Split bearer. As already 7 LCIDs out of 8 LCIDs are consumed, new LCIDs cannot be assigned for these bearers. However, the extended LCID (eLCID) ranges can support this, which have 15 LCID and may continue to have max bearers per UE as 8, but it is only possible if UE capability supports the eLCID. In an embodiment, the eNB is a base station connected to the network that communicates wirelessly with mobile handsets in a 4G LTE network or 5G non-standalone (NSA) network.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The conventional technologies do not describe supporting multiple bearers. Thus, there is a need of techniques to supports multiple bearers at a time for the UE's which do not support the extended LCID (eLCID) range.

The embodiment of the present disclosure discloses an apparatus for supporting multiple bearers for a user equipment (UE) with a limited Logical Channel Identifier (LCID) in a communication network. The apparatus is configured to determine a configuration mode of a bearer to be added for the UE. The configuration mode is one of main cell group (MCG) mode and Secondary Cell Group (SCG)-split mode. Further, the apparatus is configured to allocate a LCID to the bearer based on the configuration mode of the bearer and one or more criteria. The apparatus is configured to perform, upon detecting an addition of a secondary node in the communication network, and check whether LCIDs are available for allocating corresponding bearers requiring SCG-split mode in response to the addition of the secondary node. Further, the apparatus is configured to selectively assign the LCIDs to the corresponding bearers requiring the SCG-split mode, when the LCIDs are available for the bearers. Finally, the apparatus is configured to selectively switch a set of bearers, among the bearers, into the SCG-split mode when the LCIDs are available only for the set of bearers.

An example embodiment of the present disclosure discloses a method of supporting multiple bearers for a user equipment (UE) with a limited Logical Channel Identifier (LCID) in a communication network. The method comprises determining a configuration mode of a bearer to be added for the UE. The configuration mode is one of main cell group (MCG) mode and Secondary Cell Group (SCG)-split mode. Further, the method describes allocating a LCID to the bearer based on the configuration mode of the bearer and one or more criteria. The method includes performing, upon detecting an addition of a secondary node in the communication network, checking whether LCIDs are available for allocating corresponding bearers requiring SCG-split mode in response to the addition of the secondary node. The method further includes selectively assigning the LCIDs to the corresponding bearers requiring the SCG-split mode, when the LCIDs are available for the bearers. Finally, the method discloses selectively switching a set of bearers, among the bearers, into the SCG-split mode when the LCIDs are available only for the set of bearers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1A illustrates an ENDC connection configuration, in accordance with some embodiments of the present disclosure;

FIG. 1B illustrates a flow when a UE supports eLCID, in accordance with some embodiments of the present disclosure;

FIG. 2 illustrates a block diagram of an apparatus to support for multiple bearers for UE with a LCID in a communication network, in accordance with some embodiments of the present disclosure.

FIG. 3 illustrates a flowchart of method of using reserved LCIDs for bearer type switching, in accordance with some embodiments of the present disclosure;

FIG. 4 illustrates a flowchart of a method of using available free LCIDs for bearer type switching, in accordance with some embodiments of the present disclosure;

FIG. 5 illustrates a flowchart of a method of using LCID swap, in accordance with some embodiments of the present disclosure;

FIG. 6 illustrates a method for supporting multiple bearers for UE with LCID in a communication network, in accordance with some embodiments of the present disclosure; and

FIG. 7 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer-readable medium and executed by a computer or processor, whether or not such computer or processor is explicitly shown.

### DESCRIPTION OF THE DISCLOSURE

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Generally, in E-UTRAN New Radio—Dual Connectivity (ENDC), a user traffic may be spilt at Packet Data Convergence Protocol (PDCP) layer and thus may be referred as the split bearers. The one or more data radio bearers may be established between a User Equipment (UE) and an eNB for exchanging packets. There may be one or more radio bearers and the radio bearers may be associated with a logical channel in a Medium Access Control (MAC) sub layer. The functionality of the MAC sublayer includes one or more of following: mapping between logical channels and transport channels, Multiplexing/de-multiplexing of Media Access Control Service Data Units (MAC SDUs) belonging to one or more different logical channels into/from transport blocks (TB) delivered to/from the physical layer on the transport channels, scheduling information reporting, error correction through HARQ, priority handling between the logical channels of one UE, priority handling between the UEs by means of dynamic scheduling, transport format selection, and padding.

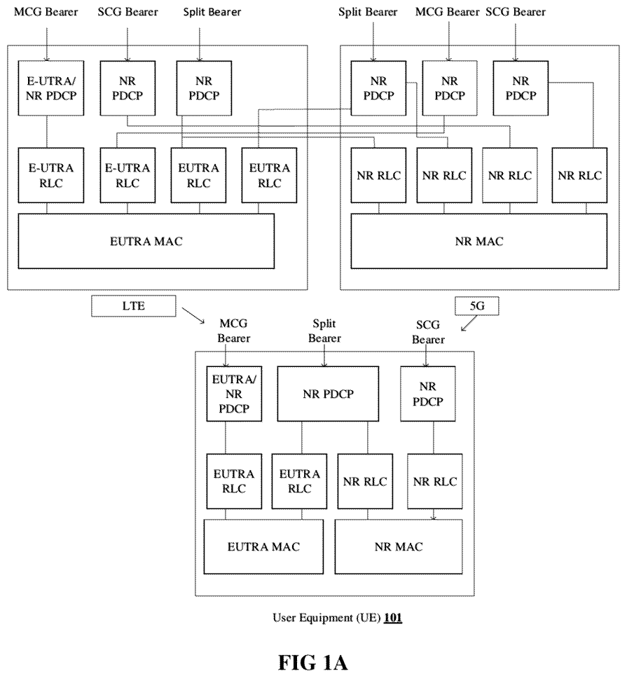

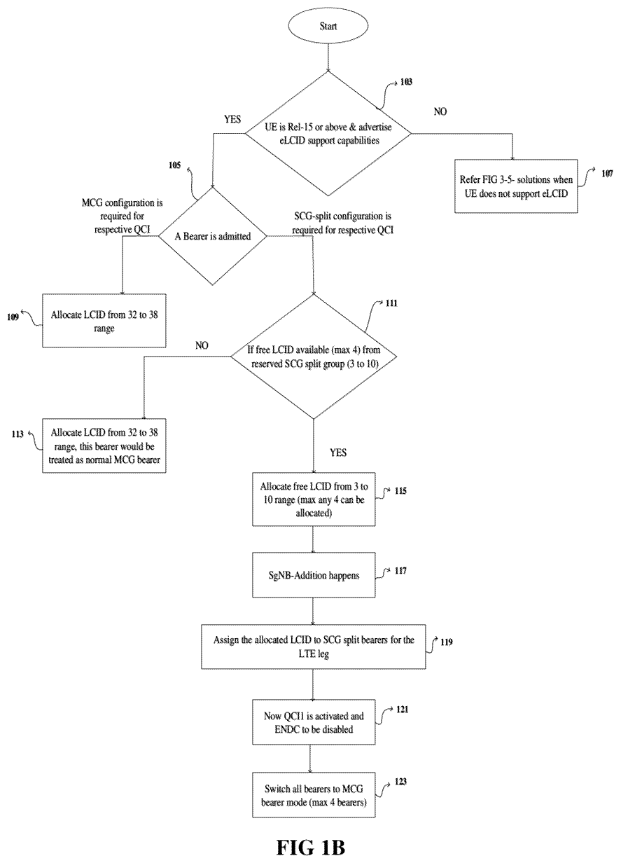

Generally, LTE supports 8 LCIDs (3 . . . 10). When any secondary node is added, the LCID may be allocated to the added node. However, the number of supported LCIDs is signaled in UE capabilities via Radio Resource Control (RRC). To support multiple ENDC bearers more LCIDs may be needed. Therefore, the present disclosure discloses techniques for supporting multiple bearers for a user equipment (UE) with a limited Logical Channel Identifier (LCID) in a communication network. In other words, the subject matter discloses a technique that focuses on updating the transition of the bearers using LCID change based mechanism. The transition in bearers may be at least one of: the Main Cell Group (MCG) bearers to/from split bearer, the MCG bearer to/from Secondary Cell Group (SCG) bearer, the SCG bearer to/from split bearer, but not limited thereto. Generally, in the ENDC, the LTE may act as the MCG and the NR may act as the SCG. In other words, the MCG split bearers may be defined as when the user plane routes the data packets to a master node but when there is a scenario that the master node is overloaded, the master node may route the traffic to the secondary node which may pass the data packets to the user equipment. In ENDC configuration, the UE may initially get connected to the LTE network and at a later point of time may be connected with the NR via an RRC connection. An exemplary ENDC connection configuration describing traffic flow of MCG bearer, SCG-split bearers are described as shown in in FIG. 1A.

The present disclosure focuses on solving the problem when the UE does not support extended LCID (eLCID). There are different methods recommended by 3GPP to support bearer type change, however the present disclosure is related to LCID change based mechanism as this is least disruptive towards the UE. The present disclosure discloses an apparatus for supporting multiple bearers for user equipment (UE) with a limited Logical Channel Identifier (LCID) in a communication network. The architecture 100 discloses communication and configuration of LTE and 5G. FIG. 1A discloses about the traffic flow of the MCG mode which describes that the bearer may be terminating at master node. For instance, in case of ENDC, at the eNB. The term terminating relates to the which node of PDCP has been used by the bearer. There are two ways for the MCG bearer configuration. The first way of MCG configuration may be with E-PDCP and the second way pf MCG configuration may be with NR-PDCP. In other words, the traffic flow in case of MCG bearers is that the traffic may be split at the PDCP layer of master node initially and flows through the MAC or RLC layer and to physical layer which may be represented as E-UTRA PDCP->E-UTRA-RLC/MAC->E-UTRA-PHY. In the second way or approach, the traffic flow in case of MCG bearers is that the traffic may be split at the PDCP layer of secondary node initially and flows through the MAC or RLC layer and to physical layer which may be represented as be the traffic flow as NR-PDCP->E-UTRA-RLC/MAC, E-UTRA-PHY. Further, when the configuration mode is SCG mode, the bearer may reside at the SN node for instance gNB. The traffic may be split at the PDCP layer of the secondary node flow through the MAC or RLC layer and to physical layer which may be represented as NR-PDCP->NR-RLC->NR-MAC. For ease of understanding, when there is extra load on MN side, few data packets may be shifted to the SN and the same may be delivered to the UE.

The apparatus configured for supporting multiple bearers for the UE with LCID in a communication network may reside within the user equipment but not limited thereto. The apparatus may comprise a processor 202 configured to determine a configuration mode of a bearer to be added for the UE. The configuration mode may be one of main cell group (MCG) mode and Secondary Cell Group (SCG)-split mode. In ENDC (Eutra NR Dual Connectivity), LTE may act as MCG and NR may be the SCG. The MCG performs as the anchor and the UE may perform initial registration to the anchor cell group, and the anchor cell adds SCG. Upon determining the configuration mode which may be the MCG or the SCG, the processor 202 may allocate the LCID to the bearer based on the configuration mode of the bearer and one or more criteria. When any secondary node is added to the communication network, the processor 202 may check whether LCIDs are available for allocating corresponding bearers requiring SCG-split mode in response to the addition of the secondary node. Based on the availability of the LCID, the processor 202 may assign the LCIDs to the corresponding bearers requiring the SCG-split mode.

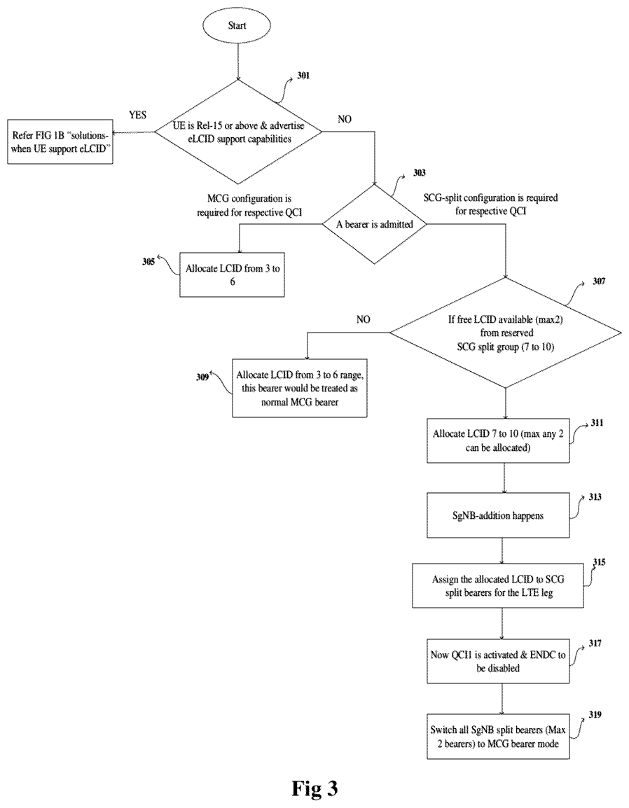

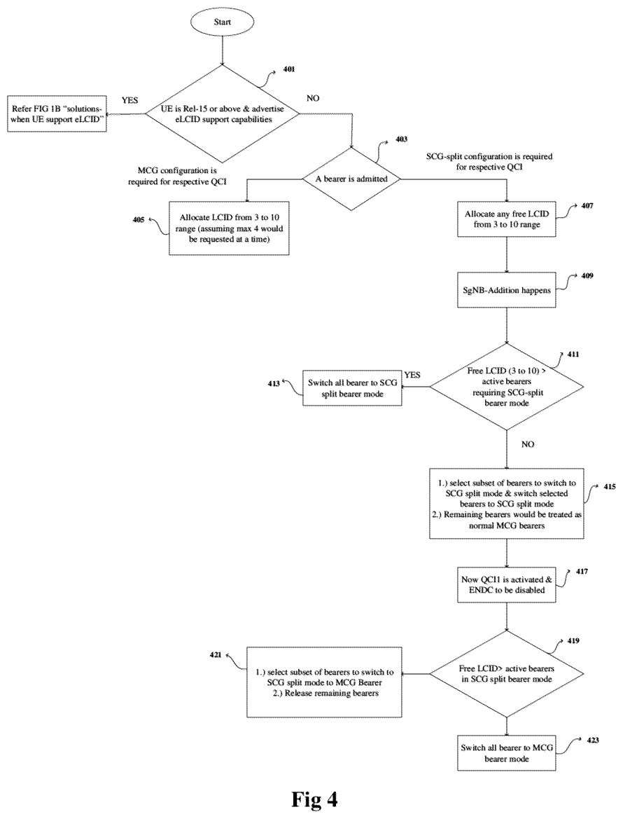

In the present disclosure, when there is an addition of secondary node, the processor 202 checks for the availability of the LCIDs. The process 202 of allocating the LCID can be performed in different ways. In an embodiment of the present disclosure, the processor 202 may initially determine the configuration mode of a bearer as there are limited LCIDs available for the UE in the communication network which may be LCID-3 to LCID-10. The configuration mode can be of MCG mode and SCG-split mode. According to the present, embodiment the LCIDs may reserve for bearer type switching. For instance, when the configuration mode is the MCG mode, the processor 202 may allocate the LCID from a first range of LCIDs. In other words, the processor 202 may select a range from the LCID-3 to LCID-6 for MCG mode when LCIDs are reserved for bearer type switching. Further, when the configuration mode is SCG split mode, the processor 202 may allocate range from LCIDs-7 to LCID-10 when the LCIDs are reserved for the bearer type switching. The allocation of LCID may be performed based on determining if the LCID is available or not. When there is a secondary node added to the communication network, the processor 202 may be allocate LCID 3-LCID 6 when QCI is MCG bearers and if the QCI is configured as the SCG-split bearer and when free LCID is not available from reserved SCG split group (7 to 10), then the processor 202 may allocate LCID range of 3 to 6 range and the bearer is treated as normal MCG bearer. However, when free LCID is not available, LCID from 7 to 10 is allocated by the processor 202 as shown in flowchart of FIG. 3. In another embodiment of the present disclosure, the processor 202 may check if LCID are reserved. When there are no reserved LCIDS, then the processor 202 may allocates free available LCIDs for bearer type switching. For ease of understanding, when the configuration mode of a bearer is MCG, the processor 202 may select a range from the LCID-3 to LCID-10. The LCID-3 to LCID 10 is unreserved for the bearer type switching and a maximum four LCIDs are required at a time in case of MCG configuration mode. Further, for SCG split bearers, the processor 202 may select a range from LCID-3 to LCID-10 in which LCIDs are unreserved for bearer type switching. In other words, the processor 202 may check if the availability of the free LCID is greater than the active bearers of SCG-split mode. The processor 202 may switch all bearers to SCG split mode when the available of free LCID is greater than the active bearers of SCG-split mode. However, when the available of free LCID is less than the active bearers of SCG-split mode, the processor 202 may switch the bearers to SCG split mode and remaining bearers may be treated as normal MCG bearers. The allocation of LCID may be performed based on comparing a number of available LCIDs and a number of active bearers requiring the SCG-split mode when the LCIDs are unreserved for the bearer type switching as shown in flowchart of FIG. 4.

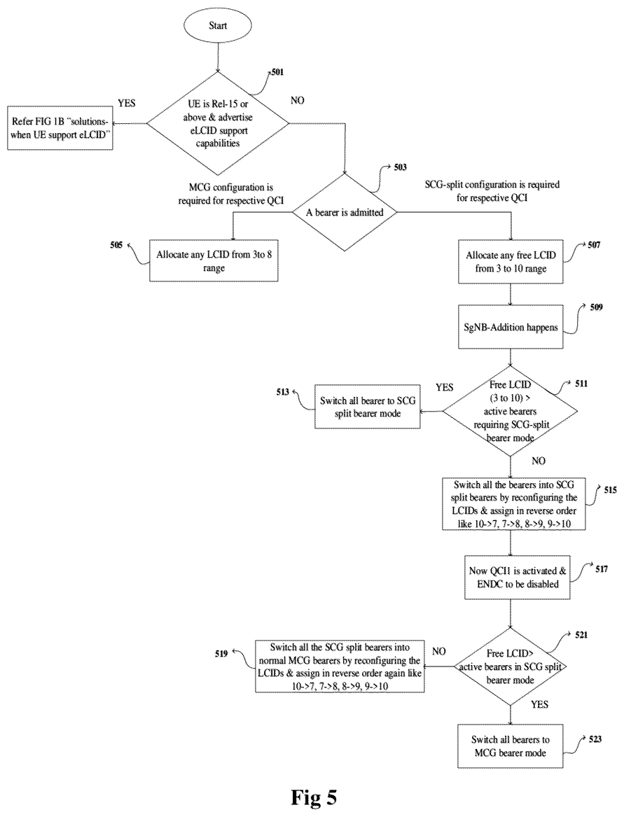

In yet another embodiment of present disclosure, based on the configuration mode, the processor 202 may select a range from the LCID-3 to LCID-8 when the LCIDs that are unreserved for the bearer type switching in case of MCG configuration mode. Further, the processor 202 may select a range from LCID-3 to LCID-10 when LCIDs that are unreserved for bearer type switching for SCG-Split mode. When there is addition of a secondary node to the communication network, the processor 202 may check if the availability of free LCID is greater than that of active bearers requiring for SCG-split mode. When there is availability of free LCID, then the processor 202 may switch all the bearers to SCG-split mode and when the availability of free LCID is less, then the processor may switch all the bearers to SCG-split mode by reconfiguring the LCID in reverse order. The allocation of LCID may be performed based on comparing a number of available LCIDs and a number of active bearers requiring the SCG-split mode when the LCIDs are unreserved for the bearer type switching. The above process of the embodiment is detailly explained in the flowchart of FIG. 5.

FIG. 1B illustrates a flow when a UE 101 supports eLCID, in accordance with some embodiments of the present disclosure. FIG. 1B illustrates the flow when the UE 101 supports eLCID support capabilities. In other words, the processor 202 may check if the UE supports eLCID [as shown in step 103 of FIG. 1B]. If the UE 101 does not support eLCID, then any of the below flow chart 3, 4 or 5 may be performed [as shown in step 107 of FIG. 1B]. If the UE 101 supports eLCID, then the processor 202 may allocate LCID32 to LCID 38 for MCR configuration mode [as shown in step 109 of FIG. 1B]. For SCG spilt mode, the processor 202 may check if there are free LCID available which may be maximum four from the reserved SCG split group as shown in step 111 of FIG. 1B. If there is no availability of LCID, then the processor 202 may allocate a range of LCID from LCID 32 to LCID 38 which may be treated as normal MCG bearer [as shown in step 113 of FIG. 1B]. If there is a free availability of LCID, then the processor 202 may allocate a range of LCID 3 to LCID 10 in which maximum 4 LCID may be allocated [as shown in step 115 of FIG. 1B]. Further, the processor 202 may check if there is addition of secondary node to the communication network [as shown in step 117 of FIG. 1B]. If any secondary node is added, the processor 202 may allocate free LCID from LCID 3 to LCID 10 may be allocated [as shown in step 119]. When the QCI-1 is activated and ENDC to be disabled [as shown in step 121 of FIG. 1B], the processor 202 may switch all the split bearers to MCG bearer mode & allocate all the free LCID (max 4 LCID) [as shown in step 123 of FIG. 1B]

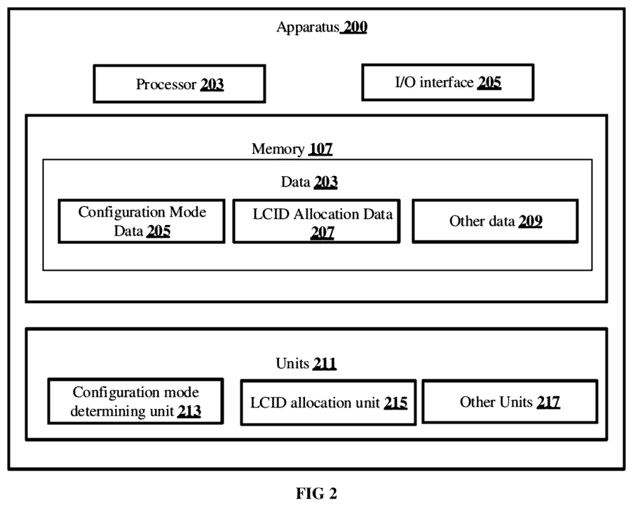

FIG. 2 shows a detailed block diagram of an apparatus 200 illustrating support for multiple bearers for UE 101 with a LCID in a communication network, in accordance with some embodiments of the present disclosure.

In an implementation, an apparatus 200 may include an I/O interface 206, a processor 202, and a memory 204. The I/O interface may be configured to communicate with one or more sources and/or external for determining a configuration mode of a bearer to be added for the UE 101. In an embodiment, the memory 204 may be communicatively coupled to the processor 202. The processor 202 may be configured to perform one or more functions of the apparatus 101.

In some implementations, the apparatus 200 may include data 208 and units 210 for performing various operations in accordance with the embodiments of the present disclosure. In an embodiment, the data 208 may be stored within the memory 204 and may include, but not limited to, configuration mode data 212, LCID allocation data 214 and other data 216.

In some embodiments, the data 208 may be stored within the memory 204 in the form of various data structures. Additionally, the data 208 may be organized using data models, such as relational or hierarchical data models. The other data 216 may store temporary data and temporary files, generated by the units while performing various functions of the apparatus 200.

In an embodiment, the data 208 may be processed by one or more units 210 of the apparatus 200. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. In an embodiment, the other units may be used to perform various miscellaneous functionalities of the apparatus 101. It will be appreciated that such units 210 may be represented as a single module or a combination of different units.

In one implementation, the one or more units may be stored as instructions executable by the processor. In another implementation, each of the one or more units may be separate hardware units, communicatively coupled to the processor for performing one or more functions of apparatus. The one or more units may include, without limiting to, a configuration mode determining unit 218, LCID allocation unit 220 and other units 221.

The present disclosure discloses that the processor 202 or the configuration mode determining unit 218 may determine that configuration mode data which corresponds to configuration mode of the bearer to be added for the UE 101. The configuration mode may be MCG mode or SCG split mode, but not limited thereto. The MCG mode may describe a bearer terminating at master node for instance, in case of ENDC, at the eNB. The term terminating relates to the which node of PDCP has been used by the bearer. The MCG bearer may be configured with at least one of E-PDCP or NR-PDCP. Further, when the configuration mode is SCG mode, the bearer may reside at the SN node for instance gNB.

In the present disclosure, the processor 202 or LCID allocation unit 220 may allocate LCID the MCG bearers and the SCG-split bearers. The processor 202 may selectively allocate the LCID from a first range of LCIDs determined based on the one or more criteria when the configuration mode is the MCG mode. Further, the processor 202 may selectively allocate the LCID from a second range of LCIDs determined based on the one or more criteria, when the configuration mode is the SCG-split mode.

In one embodiment of the present disclosure, the processor 202 may select the range from the LCID-3 to LCID-6 when LCIDs that are reserved for bearer type switching for MCG bearers [as shown in step 305 of FIG. 3]. Further, when the processor 202 determines it to be a SCG split mode which is also defined as second range, then the processor 202 may check if there are any free LCID available from the reserved SCG split group [as shown in step 307 of FIG. 3]. When there are no free LCID, then the processor 202 may allocate LCID3-LCID 6 [ass shown in step 309 of FIG. 3]. When there are free LCID, then the processor 202 may allocate LCID7-LCID 10 for SCG split mode [as shown in step 311 of FIG. 3]. The processor 202 may detect if there is an addition of a secondary node in the communication network [as shown in step 313 of FIG. 3]. In other words, the processor 202 may determine whether the LCID is available from the second range of LCIDs. When there is availability of LCID, the processor 202 may allocate the LCID available from the second range. When the LCID is unavailable, the processor 202 may allocate LCID from the first range of LCIDs, wherein the bearer of the SCG-split mode is considered as the MCG mode when the LCID is allocated from the first range of LCIDs. In other words, when there are LCID from the reserved SCG split group, then the processor 202 may assign LCIDs-7 to LCID-10. On the other hand, when there are no free LCID from the reserved SCG split group, the processor 202 may allocate LCID from 3 to 6 range and the bearer may be treated as the MCG bearer.

Furthermore, the processor 202 may detect an activation of QCI-1 and disabling of E-UTRAN New Radio Dual Connectivity (ENDC). In response, the processor 202 may determine a number of available LCIDs available [as shown in step 317 of FIG. 3]. When the number of available LCIDs are greater than the number of the active bearers in the SCG-split mode, the processor 202 may switch all the active bearers to the MCG mode. Further, when the number of available LCIDs are less than the number of the active bearers in the SCG-split mode, the processor 202 may switch at least a set of the bearers among the active bearers in the SCG-split mode to the MCG mode [as shown in step 319 of FIG. 3].

According to the above-mentioned embodiment, the LCID 3 to 6 may be reserved for the MCG bearers and the LCID 7 to 10 may be reserved for SCG split bearers. According to this approach, a maximum of six bearers i.e., four MCG bearers and two SCG split bearers may be supported at a time. Now, if the UE 101 does not support the eLCID, a maximum of two SCG split bearers may be supported by reserving the LCID's for the MCG and SCG split bearers separately.

In case more than two MCG bearers are to be converted into the SCG split mode, then only the first two bearers may be converted on the first come first serve basis and rest of the bearers would be treated as normal MCG bearer. To support this case, the conversion would be based on E-UTRAN Radio Access Bearer (ERAB-ID) and the lowest ERAB-ID will have highest priority. Further, during the deactivation of the ENDC (when QCI1 is active) all the active SCG split bearers may be switched to normal MCG bearer and remaining reserved SCG split bearer LCID's i.e., remaining two free LCIDs may be allocated after switching.

Further, when a bearer is admitted, if the corresponding QCI is configured as the MCG, LCID from 3 to 6 may be allocated. If the QCI is configured as the SCG-split bearer and when free LCID is not available (as it is maximum 2 only) from reserved SCG split group (7 to 10), a LCID range of 3 to 6 is allocated and the bearer is treated as normal MCG bearer. However, when free LCID is not available, LCID from 7 to 10 is allocated. Further, when SgNB addition is done at a later stage, free LCID from 7 to 10 is allocated. Furthermore, when the QCI-1 is activated and the ENDC to be disabled, all the SgNB split bearers are changed to the MCG bearer mode within reserve LCID for SgNB.

The above-mentioned approach is also given below for clarity and understanding. If UE 101 does not support eLCID:
LCID 3 to 6 would be reserved for MCG bearers.
LCID 7 to 10 would be reserved for SCG split bearers.
Max 6 bearers (4 MCG & 2 SCG split bearers) can be supported at a time.
If UE does not support eLCID, max 2 SCG split bearers would be supported by reserving LCID's for MCG and SCG split bearers separately.
   i. In case of more than 2 SCG split bearers, are there to be converted into SCG split mode then only the first 2 bearers would be converted on the first come first serve basis and remaining bearers would be treated as normal MCG bearers.
   ii. To support above case—it would be based on ERAB-ID and lowest ERAB-ID will have highest priority.
   iii. During the deactivation of ENDC (when QCI1 is active) all active SCG split bearers would be switched to normal MCG bearer and remaining reserved SCG split bearer LCID's (remaining 2 free LCIDs) would be allocated after switching
When a bearer is admitted—
   if the corresponding QCI is configured as MCG
      allocate LCID from 3 to 6
   if QCI is configured as SCG-split bearer
      if free LCID is not available (max 2) from reserved SCG split group (7 to 10)
         Allocate LCID from 3 to 6 range, this bearer would be treated as normal MCG bearer.
   else
      allocate LCID from 7 to 10 (assuming SgNB addition may happen later)
         when SgNB-addition happens—
         allocate free LCID from 7 to 10 (max 2 LCID)
         when QCI-1 is activated and ENDC to be disabled—
         switch all the SgNB split bearers to MCG bearer mode within reserve LCID for SgNB

Thus, the present disclosure may be easily implemented without changing any configurations. The approach also supports multiple ENDC bearers, and it is a best practice to implement if two SCG split bearers are limited in the network. However, a maximum of 6 bearers i.e., four MCG and two SCG split bearers may be supported at a time, as the minimum two LCIDs need to be left free. In this manner, out of 8 available LCIDs only 6 may be effectively used and only 2 SCG split bearers may be supported.

According to another embodiment of the present disclosure, the processor 202 or the LCID allocation unit 220 may perform LCID allocation to the bearers based on the configuration mode MCG or SCG split mode. The processor may selectively allocate the LCID from a first range of LCIDs determined based on the one or more criteria when the configuration mode is the MCG mode. Further, the processor 202 may selectively allocate the LCID from a second range of LCIDs determined based on the one or more criteria, when the configuration mode is the SCG-split mode.

In the embodiment of the present disclosure, the limited LCIDs available for the UE 101 in the communication network may be LCID-3 to LCID-10 and the first range (MCG bearer) of LCID may be determined by the processor 202 by selecting a range from the LCID-3 to LCID-10, when the LCIDs are unreserved for the bearer type switching and a maximum four LCIDs are required at a time [as shown in step 405 of FIG. 4]. Further, the processor 202 may select the range from LCID-3 to LCID-10 when LCIDs are unreserved for bearer type switching for the second range of LCIDs [as shown in step 407 of FIG. 4]. Thus, the processor 202 may detect an addition of a secondary node in the communication network [as shown in step 409 of FIG. 4]. When there is an addition, the processor 202 may check whether the free LCIDs are available for the allocating to the bearers requiring the SCG-split mode [as shown in step 411 of FIG. 4]. When there are free LCID, the processor 202 may switch all the bearers to SCG split bearer mode [as shown in step 413 of FIG. 4]. In other words, the processor may compare a number of available LCIDs and a number of active bearers requiring the SCG-split mode when the LCIDs are unreserved for the bearer type switching. The assigning the LCIDs to the bearers requiring the SCG-split mode based on the comparison. The assigning the LCIDs to the bearers requiring the SCG-split mode based on the comparison in which the LCIDs to the bearers requiring the SCG-split mode when the number of available LCIDs are greater than the number of active bearers requiring the SCG-split bearer mode the LCIDs to the bearers requiring the SCG-split mode [as shown in step 413 of FIG. 4]. In an alternative embodiment, the processor 202 may assign the LCIDs to the at least a set of bearers among the bearers requiring the SCG-split mode when the number of available LCIDs are less than the number of active bearers requiring the SCG-split bearer mode, the processor 202 may select the set of the bearers among the bearers requiring the SCG-split mode based on priority of the bearers and assigning the LCIDs the set of bearers [as shown in step 415 of FIG. 4]. Further, the processor 202 may detect an activation of QCI-1 and disable E-UTRAN New Radio Dual Connectivity (ENDC) to determine a number of active bearers in the SCG-split mode [as shown in step 417 of FIG. 4]. Further, the processor 202 may determine a number of available LCIDs. When the number of available LCIDs are greater than the number of the active bearers in the SCG-split mode, the processor 202 may switch all the active bearers to the MCG mode [as shown in step 423 of FIG. 4]. Further, when the number of available LCIDs are less than the number of the active bearers in the SCG-split mode, the processor may switch at least a set of the bearers among the active bearers in the SCG-split mode to the MCG mode. The switching of the bearers among the active bearers in the SCG-split mode to the MCG mode includes selecting the set of the bearers to be switched to the MCG mode based on priority of the bearers and switching the set of bearers into the MCG mode [as shown in step 421 of FIG. 4].

For ease of understanding, when the UE 101 does not support the eLCID, available free LCIDs may be used for indicating the bearer type switching or indicating the change in the bearer. FIG. 4illustrates a flowchart for using available free LCIDs for the bearer type switching in accordance with an embodiment of the present disclosure.

According to this approach, there may not be any reserved LCID. A maximum of 8 bearers i.e., in combination with the MCG and the SCG split bearers may be supported at a time if the number of MCG bearers are limited. Now, when a bearer is admitted, if the corresponding QCI is configured as the MCG bearer, an LCID from 3 to 10 may be allocated. However, if the QCI is configured as the SCG-split bearer, any free LCID from 3-10 may be allocated.

Further, when a secondary node (SN) addition happens, all the active bearers may be identified for which SCG-split bearers may be configured. Further, the number of free LCID available between 3-10 may be checked and if the number of free LCID is greater than the active bearers requiring the SCG-split bearer mode then all of them are switched to SCG-split bearer mode. Otherwise, a subset of the bearers is selected to switch to the SCG-split bearer mode from starting with QCI-9 and then going towards QCI-5. For the selected bearers, bearer mode is switched to the SCG-split bearer mode and the remaining SCG split bearers may be treated as the normal MCG bearer.

Further, when QCI-1 is activated and the ENDC to be disabled, a number of active bearers may be identified which are in the SCG-split bearer mode. Further, the number of free LCID available between 3-10 is checked and if the number of free LCID is greater than the active bearers in the SCG-split bearer mode then all of them are switched to MCG bearer mode. Otherwise, a subset of the bearers is selected to switch to the MCG bearer mode by starting with QCI-9 and then going towards QCI-5. The selected bearers are switched to MCG bearers and the remaining bearers may be released. The UE 101 is allowed to activate the released bearers again if required.

The above-mentioned approach is also given below for clarity and understanding. If UE 101 does not support eLCID—
No reserved LCID would be there.
Max 8 bearers (in combination of MCG & SCG split bearers) can be supported at a time if the number of MCG bearers are limited.
When a bearer is admitted—
if the corresponding QCI is configured as MCG
   allocate LCID from 3 to 10
if QCI is configured as SCG-split bearer
   allocate any free LCID from 3-10
      When SgNB-Addition happens—
         Identify all the active bearers for which SCG-split bearer is configured.
         Check number of free LCID available between 3-10.
         if free LCID > active bearers requiring SCG-split bearer mode then switch all of them to SCG-split bearer mode.
         else (select subset of the bearers to switch to SCG-split).
         Start with QCI-9 and then go towards QCI-5.
         For the selected bearers switch to SCG-split bearer mode.
         Remaining SCG split bearers would be treated as normal MCG bearers.
      When QCI-1 is activated and ENDC to be disabled:
         Identify number of active bearers which are in SCG-split bearer mode.
         Check number of free LCID available between 3-10.
         if free LCID > active bearers in SCG-split bearer mode then switch all of them to MCG bearer mode.
         else (select subset of the bearers to switch to MCG).
         Start with QC1-9 and then go towards QCI-5. For the selected bearers switch to MCG bearer.
         For the remaining bearers-Release them =>let UE 101 activate it again if required.

Thus, by using available free LCIDs for bearer type switching, the apparatus may not change any configuration. Further, the above-mentioned approach may support multiple ENDC bearers and maximum 8 bearers may be supported at a time if the number of the MCG bearers are limited. However, if the number of MCG bearers are more, then supported SCG split bearers would be limited. Further, during the deactivation of ENDC, if the number of active bearers is in full capacity or number of free LCID is less than the number of active SCG bearers, then remaining SCG split bearers would be released.

In the yet other embodiment of the present disclosure, the processor 202 or LCID allocation unit 220 may allocate LCID to the bearers based on the configuration mode which may be MCG and SCG split mode. The LCID allocation unit 220 or processor 202 may selectively allocate the LCID from a first range of LCIDs determined based on the one or more criteria when the configuration mode is the MCG mode. Further, the processor 202 may selectively allocate the LCID from a second range of LCIDs determined based on the one or more criteria, when the configuration mode is the SCG-split mode.

In the embodiment of the present disclosure, processor 202 may select a range from the LCID-3 to LCID-8 when the LCIDs are unreserved for the bearer type switching for MCG bearers [as shown in step 505 of FIG. 5]. Further, for the SCG split mode, the processor 202 may select LCID-3 to LCID-10 when LCIDs are unreserved for bearer type switching [as shown in step 507 of FIG. 5]. When there is an addition [as shown in step 509 of FIG. 5], the processor may check whether the LCIDs are available for the allocating to the bearers requiring the SCG-split mode [as shown in step 511 of FIG. 5]. Further, the processor 202 may check whether the LCIDs are available for allocating to the bearers requiring the SCG-split mode. The process of checking the availability of LCID may be done by selectively comparing a number of available LCIDs and the number of active bearers requiring the SCG-split mode when the LCIDs are unreserved for the bearer type switching.

The processor 202 may assign the LCIDs to at least a set of bearers among the bearers requiring the SCG-split mode when the number of available LCIDs are greater than the number of active bearers requiring the SCG-split bearer mode [as shown in step 515 of FIG. 5]. Further, the processor 202 may assign the LCIDs to the at least a set of bearers among the bearers requiring the SCG-split mode when the number of available LCIDs are less than the number of active bearers requiring the SCG-split bearer mode in reverse order to the bearers requiring the SCG split mode by reconfiguring the LCIDs [as shown in step 515 of FIG. 5]. When there is activation of QCI-1 and disabling of E-UTRAN New Radio Dual Connectivity (ENDC) [as shown in step 517 of FIG. 5]. The processor 202 determines a number of active bearers in the SCG-split mode. Further, the processor 202 may determine a number of available LCIDs available. When the number of available LCIDs are greater than the number of the active bearers in the SCG-split mode, the processor may switch all the active bearers to the MCG mode [as shown in step 523 of FIG. 5]. Particularly, switching the at least set of the bearers among the active bearers in the SCG-split mode to the MCG mode where all the bearers into the MCG split mode by reconfiguring the LCIDs and assigning the LCIDs in reverse order [as shown in step 519 of FIG. 5].

For ease of understanding, when the UE 101 does not support the eLCID, LCID swap may be used for indicating the bearer type switching or indicating the change in the bearer. FIG. 2C illustrates a flowchart for using LCID swap for the bearer type switching in accordance with an embodiment of the present disclosure.

According to this approach, there may not be any reserved LCID. A maximum of 8 bearers in combination of the MCG and SCG split bearers may be supported at a time without any limitation. However, reconfiguration of the LCIDs may be required during switching in between the MCG bearer mode to the SCG split bearer mode and vice-versa.

In this approach, when a bearer is admitted, it is determined whether the corresponding QCI is configured as the MCG bearer or the SCG split bearer. When the corresponding QCI is configured as the MCG bearer, a LCID from 3 to 10 may be allocated. When the QCI is configured as the SCG-split bearer, any free LCID from 3-10 may be allocated.

Further, when there is addition of secondary node, all the active bearers are identified for which SCG-split bearer is configured and number of free LCID available between 3-10 is checked. If the number of free LCIDs is greater than the active bearers requiring the SCG-split bearer mode, then all of them are switched to SCG-split bearer mode. However, if the number of free LCIDs is not greater than the active bearers requiring the SCG-split bearer mode, all the bearers are switched into the SCG split bearers by reconfiguring the LCIDs and by assigning it in reverse order like 10->7, 7->8, 8->9, 9->10.

Further, when QCI-1 is activated and the ENDC is to be disabled, a number of active bearers which are in SCG-split bearer mode are identified. Further, a number of free LCID available between 3-10 is checked and if the number of the free LCID is greater than the active bearers in the SCG-split bearer mode then all of them are switched to the MCG bearer mode. Otherwise, all the SCG split bearers are switched into the normal MCG bearers by reconfiguring the LCIDs and assigning it in reverse order again like 10->7, 7->8, 8->9, 9->10.

The above-mentioned approach is also given below for clarity and understanding. If UE does not support eLCID—
No reserved LCID would be there.
Max 8 bearers (in combination of MCG & SCG split bearers) can be supported at a time without any limitation.
Reconfiguration of LCIDs would be required during switching in between MCG to SCG split mode and vice-versa.
When a bearer is admitted—
if the corresponding QCI is configured as MCG
   allocate LCID from 3 to 10
if QCI is configured as SCG-split bearer
   allocate any free LCID from 3-10
      When SgNB-addition happens—
         Identify all the active bearers for which SCG-split bearer is configured.
         Check the number of free LCIDs available between 3-10
         if—free LCID > active bearers requiring SCG-split bearer mode then switch all of them to SCG-split bearer mode
         else—switch all the bearers into SCG split bearers by reconfiguring the LCIDs and assign in reverse order like 10->7, 7->8, 8->9, 9->10.
      When QCI-1 is activated and ENDC is to be disabled-
         Identify the number of active bearers which are in SCG-split bearer mode.
         Check the number of free LCID available between 3-10.
         if—free LCIDs > active bearers in SCG-split bearer mode then switch all of them to MCG bearer mode.
         else—switch all the SCG split bearers into normal MCG bearers by reconfiguring the LCIDs and assign in reverse order again like 10->7, 7->8, 8->9, 9->10.

Thus, the above-mentioned approach supports multiple ENDC bearers and maximum 8 bearers can be supported at a time without any limitation. However, the above approach discloses a complex configuration and reconfiguration of LCIDs during switching of bearer mode (MCG to SCG split & vice-versa) would be needed support from Layer 2 and Layer 3.

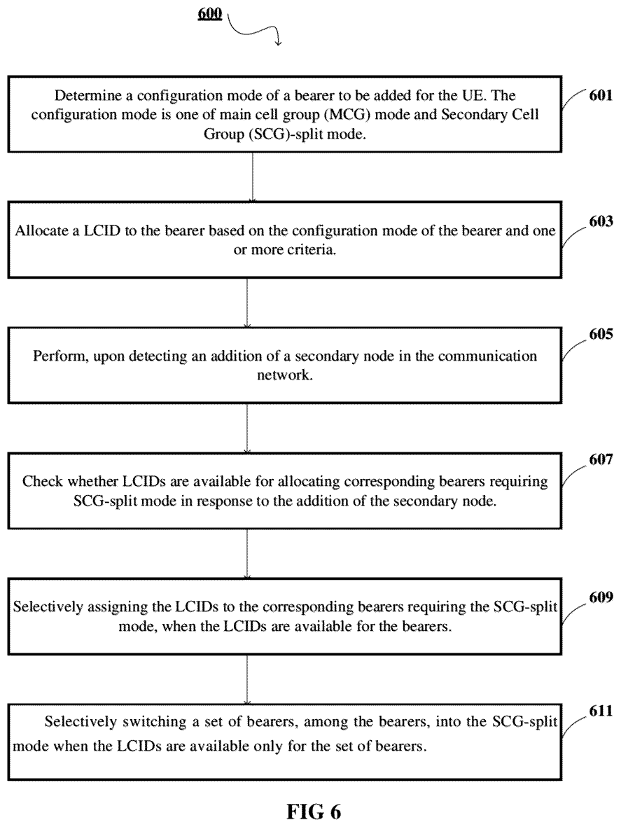

FIG. 6 shows an exemplary flow chart illustrating method steps supporting multiple bearers for a user equipment (UE) 101 with a limited Logical Channel Identifier (LCID) in a communication network, in accordance with some embodiments of the present disclosure. As illustrated in FIG. 6, the method 600 may comprise one or more steps. The method 600 may be described in the general context of computer executable instructions. Generally, computer executable instructions can include routines, programs, objects, components, data structures, procedures, units, and functions, which perform particular functions or implement particular abstract data types.

The order in which the method 600 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 601, the method recites determining the configuration mode of a bearer to be added for the UE 101, wherein the configuration mode is one of main cell group (MCG) mode and Secondary Cell Group (SCG)-split mode.

At step 603, the method recites allocating a LCID to the bearer based on the configuration mode of the bearer and one or more criteria. The allocation of a LCID from a first range of LCIDs determined based on the one or more criteria, when the configuration mode is the MCG mode. Further, the allocation of a LCID from a second range of LCIDs determined based on the one or more criteria, when the configuration mode is the SCG-split mode. For the MCG mode, the method recites selecting a range from the LCID-3 to LCID-6 when LCIDs are reserved for bearer type switching. For unserved mode, the processor 202 selects a range from the LCID-3 to LCID-8 and when four LCIDs are required, the method recites selecting range from the LCID-3 to LCID-10 when the LCIDs are unreserved for the bearer type switching and a maximum four LCIDs are required at a time. Further, for the SCG split mode, the processor 202 may select a range from LCID-3 to LCID-10 when LCIDs are unreserved for bearer type switching and a range from LCIDs-7 to LCID-10 when the LCIDs are reserved for the bearer type switching.

At step 605, the processor may check whether LCIDs are available for allocating corresponding bearers requiring SCG-split mode in response to the addition of the secondary node.

At step 607, upon checking whether LCIDs are available for allocating corresponding bearers requiring SCG-split mode in response to the addition of the secondary node.

At step 607, the processor may at step 609, the processor 202 may selectively assign the LCIDs to the corresponding bearers requiring the SCG-split mode, when the LCIDs are available for the bearers. In one embodiment, if their addition of secondary node to the communication network, the processor 202 may determine whether the LCID is available from the second range of LCIDs. When there is availability of LCID, the processor 202 may allocate the LCID available from the second range. When the LCID is unavailable, the processor 202 may allocate LCID from the first range of LCIDs. In other embodiment, when the LCIDs are available for the allocating to the bearers requiring the SCG-split mode. The process of checking the availability of LCID may be done by selectively comparing a number of available LCIDs and the number of active bearers requiring the SCG-split mode when the LCIDs are unreserved for the bearer type switching.

At step 611, the processor may switch a set of bearers, among the bearers, into the SCG-split mode when the LCIDs are available only for the set of bearers.

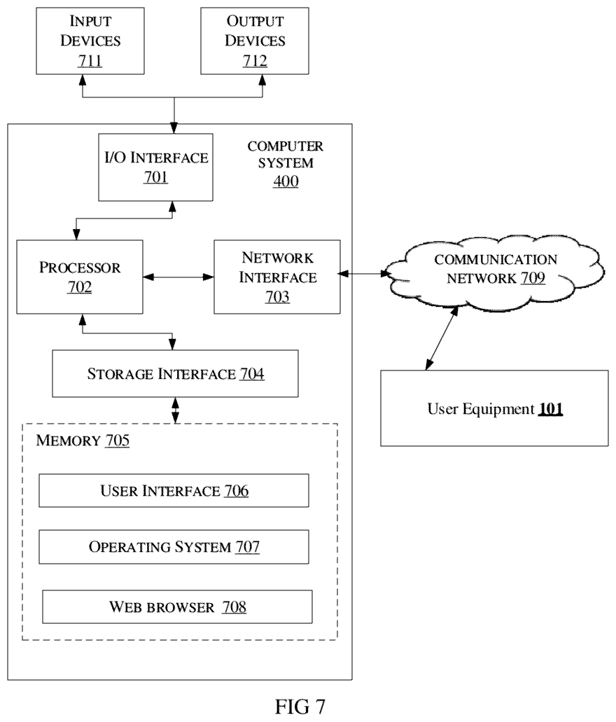

FIG. 7 is a block diagram of an exemplary apparatus 400 for implementing embodiments consistent with the present disclosure.

In some embodiments, FIG. 7 illustrates a block diagram of an exemplary apparatus which may be a computer system 700 for implementing embodiments consistent with the present disclosure. The computer system 700 may include a central processing unit (“CPU” or “processor”) 702. The processor 702 may include at least one data processor 702 for executing program components for executing user or system-generated business processes. A user may include a person, a person using a device such as such as those included in this invention, or such a device itself. The processor 702 may include specialized processing units such as integrated system (bus) controllers, memory management control units, floating point units, graphics processing units, digital signal processing units, etc.

The processor 702 may be disposed in communication with input devices 711 and output devices 712 via I/O interface 701. The I/O interface 701 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc. Using the I/O interface 701, computer system 700 may communicate with input devices 711 and output devices 712.

In some embodiments, the processor 702 may be disposed in communication with a communication network 709 via a network interface 703. The network interface 703 may communicate with the communication network 709. The network interface 703 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 703 and the communication network. The communication network 709 can be implemented as one of the different types of networks, such as intranet or Local Area Network (LAN), Closed Area Network (CAN). The communication network 709 may either be a dedicated network or a shared network, which represents an association of the different types of networks that use a variety of protocols, for example, Hypertext Transfer Protocol (HTTP), CAN Protocol, Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The user device may include, but not limited to, a mobile phone, a tablet, a laptop and the like. In some embodiments, the processor 702 may be disposed in communication with a memory 705 (e.g., RAM, ROM, etc. not shown in FIG.) via a storage interface 704. The storage interface 704 may connect to memory 705 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 705 may store a collection of program or database components, including, without limitation, a user interface 706, an operating system 707, a web browser 408 etc. In some embodiments, the computer system 700 may store user/application data, such as the data, variables, records, etc. as described in this invention. Such databases may be implemented as fault-tolerant, relational, scalable, secure databases such as Oracle or Sybase.

The operating system 707 may facilitate resource management and operation of the computer system 400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS®, GOOGLETM ANDROIDTM, BLACKBERRY® OS, or the like. The User interface 406 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the computer system 700 may implement the web browser 308 stored program components. The web browser 308 may be a hypertext viewing application, such as MICROSOFT® INTERNET EXPLORER®, GOOGLETM CHROMETM, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 308 may utilize facilities such as AJAX, DHTML, ADOBE® FLASH®, JAVASCRIPT®, JAVA®, Application Programming Interfaces (APIs), etc. In some embodiments, the computer system 700 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 300 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present disclosure. A computer-readable storage medium refers to any type of physical memory on which information or data readable by a processor 702 may be stored. Thus, a computer-readable storage medium may store instructions for execution by one or more processor 702, including instructions for causing the processor 702 to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

1. An apparatus for supporting multiple bearers for a user equipment (UE) with a limited Logical Channel Identifier (LCID) in a communication network, the apparatus configured to:
determine a configuration mode of a bearer to be added for the UE, wherein the configuration mode is one of main cell group (MCG) mode and Secondary Cell Group (SCG)-split mode;
allocate a LCID to the bearer based on the configuration mode of the bearer and one or more criteria;
perform, upon detecting an addition of a secondary node in the communication network,
check whether LCIDs are available for allocating corresponding bearers requiring SCG-split mode in response to the addition of the secondary node;
selectively assign the LCIDs to the corresponding bearers requiring the SCG-split mode, when the LCIDs are available for the bearers; and
selectively switch a set of bearers, among the bearers, into the SCG-split mode when the LCIDs are available only for the set of bearers.

2. The apparatus of claim 1, wherein allocating the LCID to the bearer based on the configuration mode of the bearer comprises:
selectively allocate a LCID from a first range of LCIDs determined based on the one or more criteria, when the configuration mode is the MCG mode; and
selectively allocate a LCID from a second range of LCIDs determined based on the one or more criteria, when the configuration mode is the SCG-split mode.

3. The apparatus of claim 2, wherein the limited LCIDs available for the UE in the communication network is LCID-3 to LCID-10, and wherein the first range of LCIDs is determined based on the one or more criteria by:
select a range from the LCID-3 to LCID-6 when LCIDs are reserved for bearer type switching;
select a range from the LCID-3 to LCID-8 when the LCIDs are unreserved for the bearer type switching; and
select a range from the LCID-3 to LCID-10 when the LCIDs are unreserved for the bearer type switching and a maximum four LCIDs are required at a time.

4. The apparatus of claim 2, wherein the limited LCIDs available for the UE in the communication network is LCID-3 to LCID-10, and wherein the second range of LCIDs is determined based on the one or more criteria comprises one of:
select a range from LCID-3 to LCID-10 when LCIDs are unreserved for bearer type switching; and
select a range from LCIDs-7 to LCID-10 when the LCIDs are reserved for the bearer type switching.

5. The apparatus of claim 4, wherein when the LCIDs are reserved for the bearer type switch, allocating the LCID from the second range of LCIDs comprises:
perform, upon determining whether a LCID is available from the second range of LCIDs, at least one of:
when the LCID is available, allocate the LCID available from the second range; and
when the LCID is unavailable, allocate a LCID from the first range of LCIDs, wherein the bearer of the SCG-split mode is considered as the MCG mode when the LCID is allocated from the first range of LCIDs.

6. The apparatus of claim 1, wherein for checking whether the LCIDs are available for the allocating to the bearers requiring the SCG-split mode, the apparatus is configured to:
perform, upon determining whether LCIDs are reserved for a bearer type switching, one of:
determine reserved LCIDs among the LCIDs which are reserved for the bearer type switching; and
selectively compare a number of available LCIDs and a number of active bearers requiring the SCG-split mode when the LCIDs are unreserved for the bearer type switching.

7. The apparatus of claim 1, wherein selectively assigning the LCIDs to the corresponding bearers requiring the SCG-split mode comprises one of:
assign the reserved LCIDs to the bearers requiring the SCG-split mode when the LCIDs are reserved for the bearer type switching; and
selectively assign the LCIDs to the bearers requiring the SCG-split mode based on the comparison.

8. The apparatus of claim 7, wherein selectively assigning the LCIDs to the bearers requiring the SCG-split mode based on the comparison comprises one of:
assign the LCIDs to the bearers requiring the SCG-split mode when the number of available LCIDs are greater than the number of active bearers requiring the SCG-split bearer mode; and
assign the LCIDs to at least a set of bearers among the bearers requiring the SCG-split mode when the number of available LCIDs are less than the number of active bearers requiring the SCG-split bearer mode.

9. The apparatus of claim 8, wherein assigning the LCIDs to the at least a set of bearers among the bearers require the SCG-split mode when the number of available LCIDs are less than the number of active bearers requiring the SCG-split bearer mode, further comprises:
select the set of the bearers among the bearers requiring the SCG-split mode based on priority of the bearers and assigning the LCIDs the set of bearers; and
assign the LCIDs in reverse order to the bearers requiring the SCG split mode by reconfiguring the LCIDs.

10. The apparatus of claim 9, when the LCIDs is assigned to the set of bearers, the apparatus is configured to consider remaining bearers, among the bearers requiring the SCG-split mode, in the MCG mode.

11. The apparatus of claim 1, wherein the apparatus further configured to:
perform, upon detecting an activation of QCI-1 and disabling of E-UTRAN New Radio Dual Connectivity (ENDC),
determine a number of active bearers in the SCG-split mode, in response to the determination;
determine a number of available LCIDs available;
when the number of available LCIDs are greater than the number of the active bearers in the SCG-split mode, switch all the active bearers to the MCG mode; and
when the number of available LCIDs are less than the number of the active bearers in the SCG-split mode, switch at least a set of the bearers among the active bearers in the SCG-split mode to the MCG mode.

12. The apparatus of claim 11, wherein switching the at least set of the bearers among the active bearers in the SCG-split mode to the MCG mode comprises:
select the set of the bearers to be switched to the MCG mode based on priority of the bearers and switching the set of bearers into the MCG mode;
switch all the bearers into the MCG split mode by reconfiguring the LCIDs and assigning the LCIDs in reverse order.

13. The apparatus of claim 12, when the set of bearers is switched to the MCG mode, the apparatus is configured to release remaining bearers among the active bearers in the SCG-split mode.

14. The apparatus of claim 1, wherein allocating the LCID to the bearer based on the configuration mode of the bearer when UE supports eLCID comprises:
select a range from the LCID-32 to LCID-38, when the configuration mode is the MCG mode; and
select a range from the LCID-3 to LCID-10, when the configuration mode is the SCG split mode.

15. A method of supporting multiple bearers for a user equipment (UE) with a limited Logical Channel Identifier (LCID) in a communication network, the method comprising:
determining a configuration mode of a bearer to be added for the UE, wherein the configuration mode is one of main cell group (MCG) mode and Secondary Cell Group (SCG)-split mode;
allocating a LCID to the bearer based on the configuration mode of the bearer and one or more criteria;
performing, upon detecting an addition of a secondary node in the communication network,
checking whether LCIDs are available for allocating corresponding bearers requiring SCG-split mode in response to the addition of the secondary node;
selectively assigning the LCIDs to the corresponding bearers requiring the SCG-split mode, when the LCIDs are available for the bearers; and
selectively switching a set of bearers, among the bearers, into the SCG-split mode when the LCIDs are available only for the set of bearers.

16. The method of claim 15, wherein allocating the LCID to the bearer based on the configuration mode of the bearer comprises:
selectively allocating a LCID from a first range of LCIDs determined based on the one or more criteria, when the configuration mode is the MCG mode; and
selectively allocating a LCID from a second range of LCIDs determined based on the one or more criteria, when the configuration mode is the SCG-split mode, wherein the limited LCIDs available for the UE in the communication network is LCID-3 to LCID-10, and wherein the first range of LCIDs is determined based on the one or more criteria by:
selecting a range from the LCID-3 to LCID-6 when LCIDs are reserved for bearer type switching;
selecting a range from the LCID-3 to LCID-8 when the LCIDs are unreserved for the bearer type switching; and
selecting a range from the LCID-3 to LCID-10 when the LCIDs are unreserved for the bearer type switching and a maximum four LCIDs are required at a time.

17. The method of claim 15, wherein the limited LCIDs available for the UE in the communication network is LCID-3 to LCID-10, and wherein the second range of LCIDs is determined based on the one or more criteria comprises one of:
selecting a range from LCID-3 to LCID-10 when LCIDs are unreserved for bearer type switching; and
selecting a range from LCIDs-7 to LCID-10 when the LCIDs are reserved for the bearer type switching,
wherein when the LCIDs are reserved for the bearer type switching, allocating the LCID from the second range of LCIDs comprises:
performing, upon determining whether a LCID is available from the second range of LCIDs, at least one of:
when the LCID is available, allocating the LCID available from the second range; and
when the LCID is unavailable, allocating a LCID from the first range of LCIDs, wherein the bearer of the SCG-split mode is considered as the MCG mode when the LCID is allocated from the first range of LCIDs.

18. The method of claim 15, wherein for checking whether the LCIDs are available for the allocating to the bearers requiring the SCG-split mode, the method further comprises:
performing, upon determining whether LCIDs are reserved for a bearer type switching, one of:
determining reserved LCIDs among the LCIDs which are reserved for the bearer type switching; and
selectively comparing a number of available LCIDs and a number of active bearers requiring the SCG-split mode when the LCIDs are unreserved for the bearer type switching.

19. The method of claim 15, wherein selectively assigning the LCIDs to the corresponding bearers requiring the SCG-split mode comprises one of:
assigning the reserved LCIDs to the bearers requiring the SCG-split mode when the LCIDs are reserved for the bearer type switching; and
selectively assigning the LCIDs to the bearers requiring the SCG-split mode based on the comparison, wherein selectively assigning the LCIDs to the bearers requiring the SCG-split mode based on the comparison comprises one of:
assigning the LCIDs to the bearers requiring the SCG-split mode when the number of available LCIDs are greater than the number of active bearers requiring the SCG-split bearer mode; and
assigning the LCIDs to at least a set of bearers among the bearers requiring the SCG-split mode when the number of available LCIDs are less than the number of active bearers requiring the SCG-split bearer mode, and
wherein assigning the LCIDs to the at least a set of bearers among the bearers requiring the SCG-split mode when the number of available LCIDs are less than the number of active bearers requiring the SCG-split bearer mode, further comprises:
selecting the set of the bearers among the bearers requiring the SCG-split mode based on priority of the bearers and assigning the LCIDs the set of bearers; and
assigning the LCIDs in reverse order to the bearers requiring the SCG split mode by reconfiguring the LCIDs,
when the LCIDs is assigned to the set of bearers, the method comprises considering remaining bearers, among the bearers requiring the SCG-split mode, in the MCG mode.

20. A non-transitory computer-readable storage medium, the computer-readable storage medium including instructions that when executed by a computer, cause the computer to:
determine a configuration mode of a bearer to be added for the UE, wherein the configuration mode is one of main cell group (MCG) mode and Secondary Cell Group (SCG)-split mode;
allocate a LCID to the bearer based on the configuration mode of the bearer and one or more criteria;
perform, upon detecting an addition of a secondary node in the communication network,
check whether LCIDs are available for allocating corresponding bearers requiring SCG-split mode in response to the addition of the secondary node;
selectively assign the LCIDs to the corresponding bearers requiring the SCG-split mode, when the LCIDs are available for the bearers; and
selectively switch a set of bearers, among the bearers, into the SCG-split mode when the LCIDs are available only for the set of bearers.
